(19) United States
(12) Patent Application Publication
(10) Pub. No.: US 2026/0094737 A1
(43) Pub. Date: Apr. 2, 2026

(54) TWO-QUBIT ENTANGLING GATE USING A CONTINUOUS SPIN DEPENDENT FORCE COUPLED WITH COHERENT TRAP MANIPULATION

(71) Applicant: IonQ, Inc., College Park, MD (US)

(72) Inventor: Alexander Kevin RATCLIFFE, Huntington Beach, CA (US)

(21) Appl. No.: 18/893,659

(22) Filed: Sep. 23, 2024

Related U.S. Application Data
(60) Provisional application No. 63/585,089, filed on Sep. 25, 2023.

(51) Int. Cl. G21K 1/00; G06N 10/40

(52) U.S. Cl. CPC G21K 1/20; G06N 10/40

(57) ABSTRACT

Aspects of the present disclosure relate to systems and methods in quantum information processing (QIP). The method includes determining a temporal profile of a trapping potential of an ion trap configured to trap a first trapped ion and a second trapped ion of an array of trapped ions for QIP and obtaining at least one characteristic of a first optical beam that is applied to the first trapped ion. The method includes synchronizing the at least one characteristic of the first optical beam and the temporal profile of the trapping potential and simultaneously applying the first optical beam to the first trapped ion based on the at least one characteristic and the trapping potential having the temporal profile to the ion trap. Optical beams including the first optical beam are applied to the first trapped ion and the second trapped ion.

### CROSS REFERENCE TO RELATED APPLICATIONS

The current application claims priority to U.S. Patent Provisional Application No. 63/585,089, filed on Sep. 25, 2023, the entire contents of which are hereby incorporated by reference.

### TECHNICAL FIELD

Aspects of the present disclosure relate generally to systems and methods for use in the implementation and/or operation of quantum information processing (QIP) systems, and more particularly, to operations of multiple QIP systems.

### BACKGROUND

Trapped atoms are one of the leading implementations for quantum information processing or quantum computing. Atomic-based qubits may be used as quantum memories, as quantum gates in quantum computers and simulators, and may act as nodes for quantum communication networks. Qubits based on trapped atomic ions enjoy a rare combination of attributes. For example, qubits based on trapped atomic ions have very good coherence properties, may be prepared and measured with nearly 100% efficiency, and are readily entangled with each other by modulating their Coulomb interaction with suitable external control fields such as optical or microwave fields. These attributes make atomic-based qubits attractive for extended quantum operations such as quantum computations or quantum simulations.

It is therefore important to develop new techniques that improve the design, fabrication, implementation, and/or control of different QIP systems used as quantum computers or quantum simulators, and particularly for those QIP systems that handle operations based on atomic-based qubits.

### SUMMARY

The following presents a simplified summary of one or more aspects to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

In some aspects of the present disclosure, the method includes determining a temporal profile of a trapping potential of an ion trap configured to trap a first trapped ion and a second trapped ion of an array of trapped ions for QIP and determining at least one characteristic of a first optical beam that is applied to the first trapped ion. The method includes synchronizing the at least one characteristic of the first optical beam and the temporal profile of the trapping potential and simultaneously applying the first optical beam to the first trapped ion based on the at least one characteristic of the first optical beam and the trapping potential having the temporal profile to the ion trap. Optical beams are applied to the first trapped ion and the second trapped ion to implement the two-qubit entangling gate based on the first trapped ion and the second trapped ion. The optical beams include the first optical beam.

In an example, the temporal profile of the trapping potential and the at least one characteristic of the first optical beam are determined to enhance a state dependent phase space displacement to the first trapped ion.

In an example, the determining the at least one characteristic includes determining a temporal pulse shape of the first optical beam, the at least one characteristic including the temporal pulse shape of the first optical beam.

In an example, the temporal pulse shape includes at least one of (i) an amplitude profile of the temporal pulse shape, (ii) a frequency profile of the temporal pulse shape, or (iii) a phase profile of the temporal pulse shape.

In an example, the temporal pulse shape includes the amplitude profile of the temporal pulse shape.

In an example, the temporal pulse shape includes the frequency profile of the temporal pulse shape.

In an example, the temporal pulse shape includes the phase profile of the temporal pulse shape.

In an example, the applying of the optical beams includes applying the first optical beam and a second optical beam to the first trapped ion. Frequencies of the first optical beam and the second optical beam are separated by a first frequency difference Δω1 based on an energy difference ω01 of a first qubit state and a second qubit state of the first trapped ion and a pre-defined parameter γ. The applying the optical beams includes applying a third optical beam and a fourth optical beam to the second trapped ion. Frequencies of the third optical beam and the fourth optical beam are separated by a second frequency difference Δω2 based on an energy difference ω02 of a first qubit state and a second qubit state of the second trapped ion and the pre-defined parameter γ. (i) The first optical beam and the second optical beam and (ii) the third optical beam and the fourth optical beam are applied to the first trapped ion and the second trapped ion, respectively, to implement the two-qubit entangling gate. Beam propagation directions of the first optical beam and the second optical beam may be different. Beam propagation directions of the third optical beam and the fourth optical beam may be different.

In an example, the second optical beam is the fourth optical beam, the beam propagation direction of the first optical beam is identical to the beam propagation direction of the third optical beam, and the beam propagation direction of the first optical beam is perpendicular to the beam propagation direction of the second optical beam.

In an example, the method further includes determining a temporal pulse shape of the third optical beam that is applied to the second trapped ion to enhance a state dependent phase space displacement to the second trapped ion, and the applying of the third optical beam and the fourth optical beam includes applying the third optical beam with the determined temporal pulse shape of the third optical beam and the second optical beam to the second trapped ion.

In an example, the third optical beam is the first optical beam, the beam propagation direction of the second optical beam is identical to the beam propagation direction of the fourth optical beam, and the beam propagation direction of the first optical beam is perpendicular to the beam propagation direction of the second optical beam.

In an example, the applying the trapping potential includes manipulating voltages at electrodes of the ion trap based on the determined temporal profile of the trapping potential.

In an embodiment, a quantum information processing (QIP) system includes an array of trapped ions including a first trapped ion and a second trapped ion, an optical system configured to generate optical beams including a first optical beam applied to the first trapped ion, an ion trap configured to trap the first trapped ion and the second trapped ion, and a controller configured to control operations of the optical system and the ion trap. The controller is configured to determine a temporal profile of a trapping potential of the ion trap and at least one characteristic of the first optical beam to enhance a state dependent phase space displacement to the first trapped ion. The controller is configured to synchronize the at least one characteristic of the first optical beam and the temporal profile of the trapping potential and simultaneously apply the first optical beam to the first trapped ion based on the at least one characteristic of the first optical beam and the trapping potential having the temporal profile to the ion trap, for example, from a time to to a time t1.

The controller is configured to control the optical system to apply the optical beams to the first trapped ion and the second trapped ion to implement a two-qubit entangling gate based on the first trapped ion and the second trapped ion.

In an example, the controller is configured to control the optical system and the ion trap to apply the first optical beam and the trapping potential simultaneously.

In an example, the controller is configured to determine a temporal pulse shape of the first optical beam, the at least one characteristic including the temporal pulse shape of the first optical beam.

In an example, the temporal pulse shape includes at least one of (i) an amplitude profile of the temporal pulse shape, (ii) a frequency profile of the temporal pulse shape, or (iii) a phase profile of the temporal pulse shape.

In an example, the controller is configured to control the optical system to apply the first optical beam and a second optical beam to the first trapped ion. Frequencies of the first optical beam and the second optical beam are separated by a first frequency difference Δω1 based on an energy difference ω01 of a first qubit state and a second qubit state of the first trapped ion and a pre-defined parameter γ. The controller is configured to apply a third optical beam and a fourth optical beam to the second trapped ion. Frequencies of the third optical beam and the fourth optical beam are separated by a second frequency difference Δω2 based on an energy difference ω02 of a first qubit state and a second qubit state of the second trapped ion and the pre-defined parameter γ. (i) The first optical beam and the second optical beam and (ii) the third optical beam and the fourth optical beam are applied to the first trapped ion and the second trapped ion, respectively, to implement the two-qubit entangling gate. Beam propagation directions of the first optical beam and the second optical beam are different, and beam propagation directions of the third optical beam and the fourth optical beam are different.

In an example, the second optical beam is the fourth optical beam, the beam propagation direction of the first optical beam is identical to the beam propagation direction of the third optical beam, and the beam propagation direction of the first optical beam is perpendicular to the beam propagation direction of the second optical beam.

In an example, the controller is configured to determine a temporal pulse shape of the third optical beam that is applied to the second trapped ion to enhance a state dependent phase space displacement to the second trapped ion and control the optical system to apply the third optical beam with the determined temporal pulse shape of the third optical beam and the fourth optical beam to the second trapped ion.

In an example, the third optical beam is the first optical beam, the beam propagation direction of the second optical beam is identical to the beam propagation direction of the fourth optical beam, and the beam propagation direction of the first optical beam is perpendicular to the beam propagation direction of the second optical beam.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates a view of atomic ions in a linear crystal or chain in accordance with aspects of the present disclosure.

FIG. 2 illustrates an example of a quantum information processing (QIP) system in accordance with aspects of the present disclosure.

FIG. 3 illustrates an example of a computer device in accordance with aspects of the present disclosure.

FIG. 4 shows an example of states (or qubit states) of a trapped ion in an array of trapped ions of a QPU according to an embodiment of the present disclosure.

FIG. 5 shows an example of trapped ions in an array of trapped ions of a QPU according to an embodiment of the present disclosure.

FIG. 6 shows an exemplary QIP system according to an embodiment of the disclosure.

FIG. 7 shows timing schematics of an exemplary temporal pulse shape f1(t) of a first optical beam and an exemplary temporal profile g1(t) of a trapping potential according to an embodiment of the disclosure.

FIG. 8 shows a method 800 to implement a two-qubit entangling gate using a continuous spin dependent force coupled with coherent trap manipulation according to an embodiment of the present disclosure.

FIG. 9 shows a method 900 to implement a two-qubit entangling gate using a continuous spin dependent force coupled with coherent trap manipulation according to an embodiment of the present disclosure.

### DETAILED DESCRIPTION

The detailed description set forth below in connection with the appended drawings or figures is intended as a description of various configurations or implementations and is not intended to represent the only configurations or implementations in which the concepts described herein may be practiced. The detailed description includes specific details for the purpose of providing a thorough understanding of various concepts. However, it will be apparent to those skilled in the art that these concepts may be practiced without these specific details or with variations of these specific details. In some instances, well known components are shown in block diagram form, while some blocks may be representative of one or more well known components.

Quantum computing (QC) includes methods for processing information that utilizes quantum two-level systems or quantum bits (qubits) as the fundamental unit of information storage. QC can further leverage entanglement between qubits, natively generated in QC platforms, to perform computations with fewer resources (e.g. computation time, number of bits, etc.) than classical computing schemes. In some embodiments, gate fidelities using Raman transitions are limited by scattering off an excited state. The scattering off the excited state can be resolved or mitigated by using a direct transition between two qubit states. For various qubit states, respective direction transitions between two of the qubit states can be in a frequency range of microwave (MW) or the MW spectrum. In some embodiments, spatial localization in the MW spectrum can be difficult and a speed of the transition can be slow. Further, in various examples, light or optical beams in the MW frequency may impart a much smaller state dependent force than optical beams in the visible-UV frequencies typically used in Raman transitions. Thus, in some embodiments, using MW frequency further slows down entangling gates, such as Mølmer-Sørensen (MS) gates.

Exemplary embodiments of the present disclosure include a controller (e.g., including both hardware and software) configured to implement two-qubit entangling gate using a continuous spin dependent force coupled with a coherent trap manipulation.

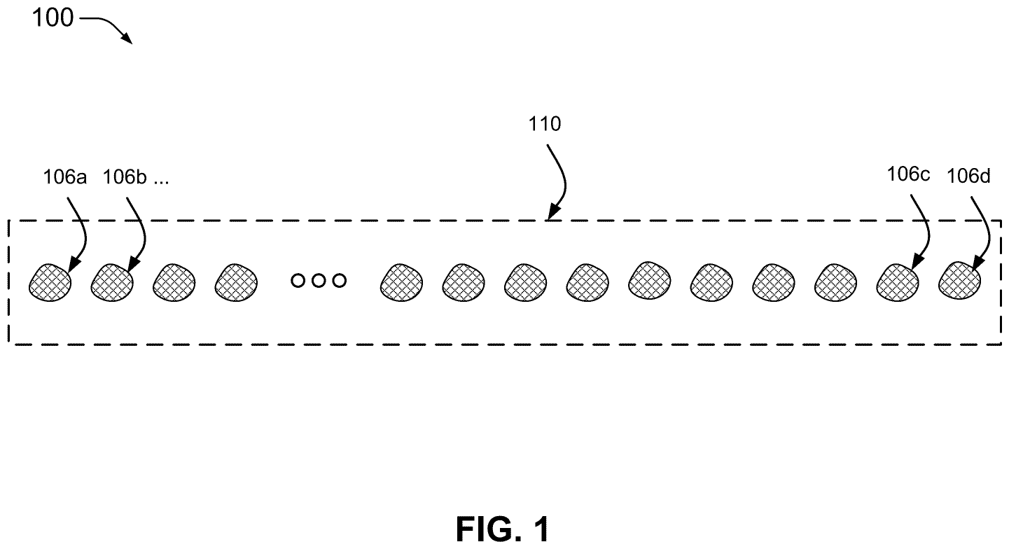

Solutions to the issues described above are explained in more detail in connection with FIGS. 1-8, with FIGS. 1-3 providing a general configuration of QIP systems or quantum computers, and more specifically, of atomic-based QIP systems or quantum computers.

Atomic quantum computers can include array(s) of atoms or ions trapped, for example, inside a vacuum chamber. A size and dimensionality of atomic arrays may vary.

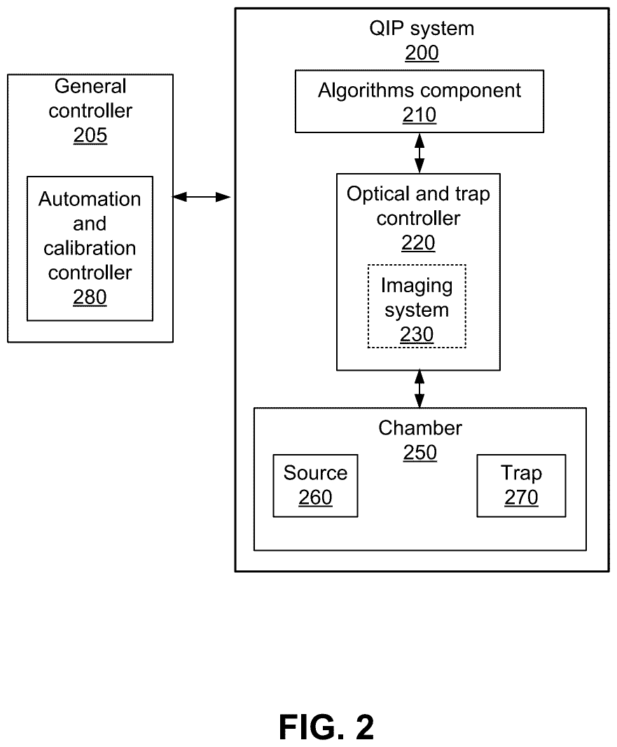

FIG. 1 illustrates a diagram 100 with multiple atomic ions 106 (e.g., atomic ions 106a, 106b, . . . , 106c, and 106d) trapped in a linear crystal or chain 110 using a trap. In an example, the trap can be inside a vacuum chamber as shown in FIG. 2. The trap may be referred to as an ion trap. The ion trap shown may be built or fabricated on a semiconductor substrate, a dielectric substrate, or a glass die or wafer (also referred to as a glass substrate). The atomic ions 106 may be provided to the trap as atomic species for ionization and confinement into the chain 110.

In the example shown in FIG. 1, the trap includes electrodes for trapping or confining multiple atomic ions into the chain 110. The multiple atomic ions can be laser-cooled to be nearly at rest. The number of atomic ions (N) trapped can be configurable and more or fewer atomic ions may be trapped. The atomic ions can be Ytterbium ions (e.g., ¹⁷¹Yb⁺ ions), for example. The atomic ions are illuminated with laser (optical) radiation tuned to a resonance in ¹⁷¹Yb⁺ and the fluorescence of the atomic ions is imaged onto a camera or some other type of detection device. Any suitable separation between atomic ions in a single cluster can be used. The separations can be uniform or non-uniform. A separation between atomic ions in a single cluster may range from 1 to 10 microns (μm). In an example, atomic ions may be separated by about 5 μm from each other, although the separation may be smaller or larger than 5 μm. The separation of the atomic ions is determined by a balance between the external confinement force and Coulomb repulsion and does not need to be uniform. In addition to atomic Ytterbium ions, neutral atoms, Rydberg atoms, different atomic ions or different species of atomic ions may be used. The trap may be a linear radiofrequency (RF) Paul trap. Other types of confinement may also be used, including optical confinements. Thus, a confinement device may be based on different techniques and may hold ions and/or neutral atoms, for example, with an ion trap being one example of such a confinement device. The ion trap may be a surface trap, for example.

FIG. 2 shows a block diagram that illustrates an example of a QIP system 200 in accordance with various aspects of this disclosure. The QIP system 200 may be referred to as a quantum computing system, a quantum computer, a computer device, a trapped ion system, or the like. The QIP system 200 may be part of a hybrid computing system in which the QIP system 200 is used to perform quantum computations and operations. The hybrid computing system can include a classical computer to perform classical computations and operations.

Shown in FIG. 2 is a general controller 205 configured to perform various control operations of the QIP system 200. Instructions for the control operations may be stored in memory (not shown) in the general controller 205 and may be updated over time through a communications interface (not shown). Although the general controller 205 is shown separate from the QIP system 200, the general controller 205 may be integrated with or be part of the QIP system 200. The general controller 205 may include an automation and calibration controller 280 configured to perform various calibration, testing, and automation operations associated with the QIP system 200.

The QIP system 200 may include an algorithms component 210 that may operate with other parts of the QIP system 200 to perform quantum algorithms or quantum operations, including a stack or sequence of combinations of single qubit operations and/or multi-qubit operations (e.g., two-qubit operations) as well as extended quantum computations. As such, the algorithms component 210 may provide instructions to various components of the QIP system 200 (e.g., to the optical and trap controller 220) to enable the implementation of the quantum algorithms or quantum operations. The algorithms component 210 may receive information resulting from the implementation of the quantum algorithms or quantum operations and may process the information and/or transfer the information to another component of the QIP system 200 or to another device for further processing.

The QIP system 200 may include an optical and trap controller 220 that controls various aspects of a trap 270 in a chamber 250, including the generation of signals to control the trap 270, and controls the operation of lasers and optical systems that provide optical beams that interact with the atoms or ions in the trap. When used to confine or trap ions, the trap 270 may be referred to as an ion trap. The trap 270, however, may also be used to trap neutral atoms, Rydberg atoms, different atomic ions or different species of atomic ions. In an example, the lasers and optical systems is at least partially located in the optical and trap controller 220 and/or in the chamber 250. For example, optical systems within the chamber 250 may be referred to as optical components or optical assemblies.

The QIP system 200 may include an imaging system 230. The imaging system 230 may include a high-resolution imager (e.g., CCD camera) or other type of detection device (e.g., a photomultiplier tube or a PMT) for monitoring the atomic ions while the atomic ions are being provided to the trap 270 and/or after the atomic ions have been provided to the trap 270. In an embodiment, the imaging system 230 can be implemented separately from the optical and trap controller 220. In an embodiment, the use of fluorescence to detect, identify, and label atomic ions using image processing algorithms may be coordinated with the optical and trap controller 220.

The QIP system 200 can include a source 260 that can provide atomic species (e.g., a plume or flux of neutral atoms) to the chamber 250 having the trap 270. When atomic ions are the basis of the quantum operations, the trap 270 can confine the atomic species when the atomic species are ionized (e.g., photoionized). The trap 270 may be part of a processor or processing portion of the QIP system 200. For example, the trap 270 may be considered as the core of the processing operations of the QIP system 200 since the trap 270 holds the atomic-based qubits that are used to perform the quantum operations or simulations. In an example, at least a portion of the source 260 may be implemented separately from the chamber 250.

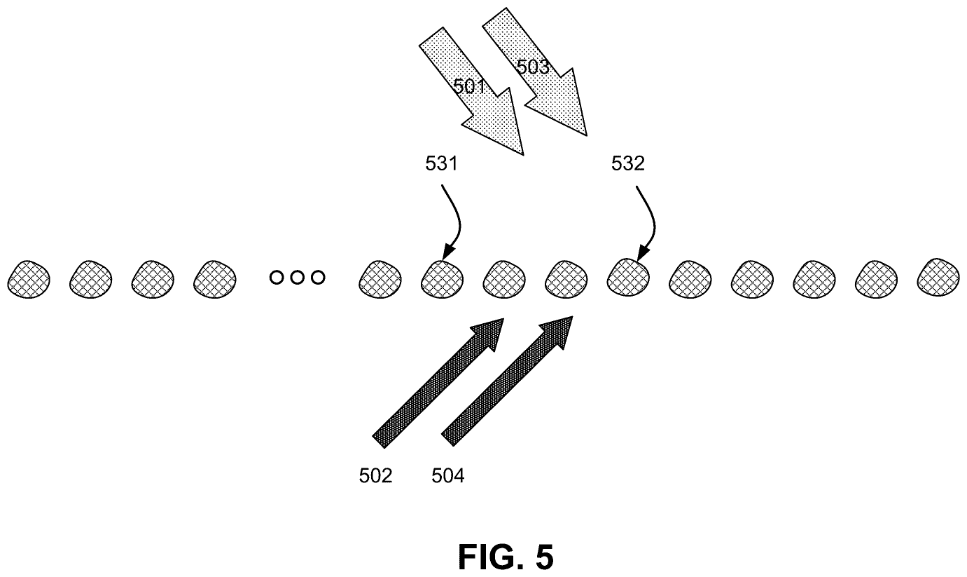

It is to be understood that the various components of the QIP system 200 described in FIG. 2 are described at a high-level for ease of understanding. Such components may include one or more sub-components, the details of which may be provided below (e.g., FIG. 5) as needed to better understand certain aspects of this disclosure.

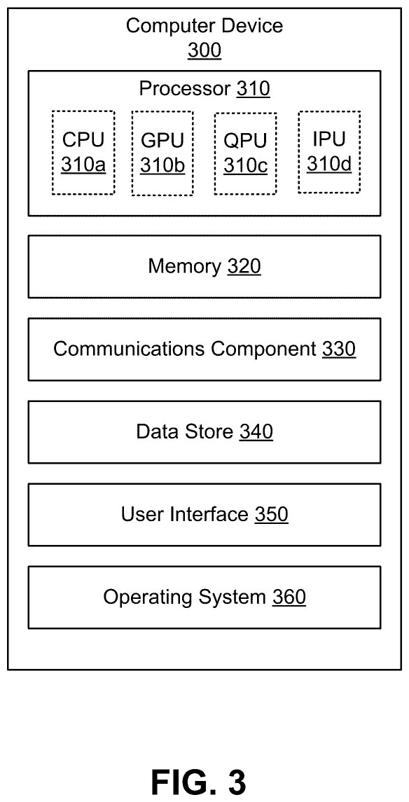

FIG. 3 shows an example of a computer system or device 300 in accordance with aspects of the disclosure. The computer device 300 can represent a single computing device, multiple computing devices, or a distributed computing system, for example. The computer device 300 may be configured as a quantum computer (e.g., a QIP system), a classical computer, or to perform a combination of quantum and classical computing functions, sometimes referred to as hybrid functions or operations. For example, the computer device 300 may be used to process information using quantum algorithms, classical computer data processing operations, or a combination of both. In some instances, results from one set of operations (e.g., quantum algorithms) are shared with another set of operations (e.g., classical computer data processing). A generic example of the computer device 300 implemented as a QIP system capable of performing quantum computations and simulations is, for example, the QIP system 200 shown in FIG. 2 or a QIP system 500 shown in FIG. 5.

The computer device 300 may include a processor 310 for carrying out processing functions associated with one or more of the features described herein. The processor 310 may include a single or multiple set of processors or multi-core processors. The processor 310 may be implemented as an integrated processing system and/or a distributed processing system. The processor 310 may include one or more central processing units (CPUs) 310a, one or more graphics processing units (GPUs) 310b, one or more quantum processing units (QPUs) 310c, one or more intelligence processing units (IPUs) 310d (e.g., artificial intelligence (AI) processors), or a combination of some or all those types of processors. In one aspect, the processor 310 may be referred to as a general processor of the computer device 300, which may also include additional processors 310 to perform more specific functions (e.g., including functions to control the operation of the computer device 300).

The computer device 300 may include a memory 320 for storing instructions executable by the processor 310 to carry out operations. The memory 320 may store data for processing by the processor 310 and/or data resulting from processing by the processor 310. In an implementation, for example, the memory 320 may correspond to a computer-readable storage medium (e.g., a non-transitory computer-readable medium) that stores code or instructions to perform one or more functions or operations. The memory 320 may be referred to as a general memory of the computer device 300, which may also include additional memories 320 to store instructions and/or data for more specific functions.

It is to be understood that the processor 310 and the memory 320 may be used in connection with different operations including but not limited to computations, calculations, simulations, controls, calibrations, system management, and other operations of the computer device 300, including any methods or processes described herein.

The computer device 300 may include a communications component 330 that provides for establishing and maintaining communications with one or more parties utilizing hardware, software, and services. The communications component 330 may also be used to carry communications between components on the computer device 300, as well as between the computer device 300 and external devices, such as devices located across a communications network and/or devices serially or locally connected to computer device 300. For example, the communications component 330 may include one or more buses, and may further include transmit chain components and receive chain components associated with a transmitter and receiver, respectively, operable for interfacing with external devices. The communications component 330 may be used to receive updated information for the operation or functionality of the computer device 300.

The computer device 300 may include a data store 340, which can be any suitable combination of hardware and/or software, which provides for mass storage of information, databases, and programs employed in connection with the operation of the computer device 300 and/or any methods or processes described herein. For example, the data store 340 may be a data repository for operating system 360 (e.g., a classical OS, or a quantum OS, or both). In one implementation, the data store 340 may include the memory 320. In an implementation, the processor 310 may execute the operating system 360 and/or applications or programs, and the memory 320 or the data store 340 may store the operating system 360 and/or applications or programs.

The computer device 300 may include a user interface component 350 configured to receive inputs from a user of the computer device 300 and further configured to generate outputs for presentation to the user or to provide to a different system (directly or indirectly). The user interface component 350 may include one or more input devices, including but not limited to a keyboard, a number pad, a mouse, a touch-sensitive display, a digitizer, a navigation key, a function key, a microphone, a voice recognition component, any other mechanism capable of receiving an input from a user, or any combination thereof. Further, the user interface component 350 may include one or more output devices, including but not limited to a display, a speaker, a haptic feedback mechanism, a printer, any other mechanism capable of presenting an output to a user, or any combination thereof. In an implementation, the user interface component 350 may transmit and/or receive messages corresponding to the operation of the operating system 360. When the computer device 300 is implemented as part of a cloud-based infrastructure solution, the user interface component 350 may be used to allow a user of the cloud-based infrastructure solution to remotely interact with the computer device 300.

In connection with the systems described in FIGS. 1-3, aspects of the present disclosure include a QIP system configured to combine a continuous state dependent force (e.g., spin dependent force) coupled with a coherent manipulation of a trap potential of an ion trap. The systems described in FIGS. 2, 3, and/or 6 may be used to control various aspects of the QIP system as described in the disclosure.

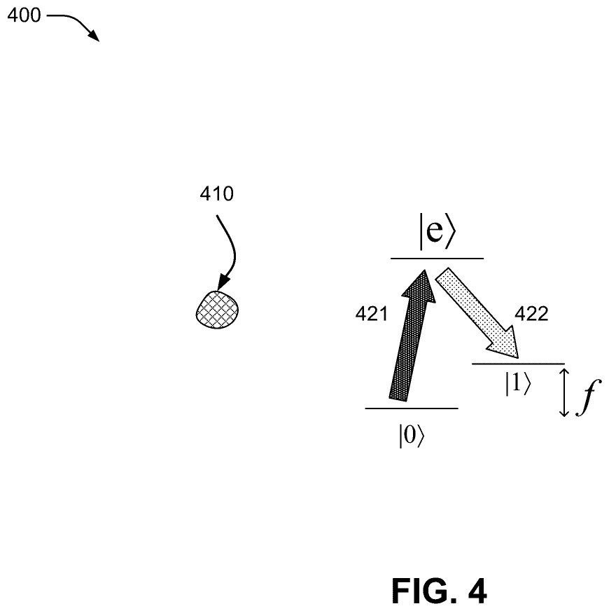

FIG. 4 shows an example of states (referred to as qubit states) of a trapped ion 410 in an array of trapped ions of a QPU or a QIP system such as the QIP system 200 described in FIG. 2 according to an embodiment of the present disclosure. The array of trapped ions can include any suitable number of trapped ions in any suitable arrangement, such as in a linear arrangement (e.g., the chain 110 described in FIG. 1), in a two-dimensional (2D) arrangement, or the like. In an embodiment, two energy levels of the trapped ion 410 may be allocated to be the qubit states including a “zero” qubit state (indicated by |0> or |↓>) and a “one” qubit state (indicated by |1> or |↑>) of a qubit. An energy difference between |0> and |1> can be indicated by a frequency ω₀, for example, the energy difference is proportional to the frequency ω₀. |0> and |1> can also be referred to as internal states of the trapped ion 410.

According to exemplary aspects, light (e.g., from the optical and trap controller 220 in FIG. 2) at certain optical frequencies can be used to drive a single qubit gate and multi-qubit gates. The light can be focused to a beam size, for example, that is less than a distance between trapped ions, and thus individually addressing qubits. In some examples, a light beam is applied to multiple trapped ions and thus addressing the multiple trapped ions as a group.

A first qubit state (e.g., |0>) can transition to a second qubit state (e.g., |1>) by the optical pulses and the trapped ion 410 can receive a force from the optical pulses. The force can be dependent on a qubit state (e.g., |0> or |1>), and can be referred to as a qubit state dependent force. The optical pulses can cause a phase space displacement to the trapped ion 410. The phase space displacement can be dependent on a qubit state (e.g., |0> or |1>), and can be referred to as a qubit state dependent phase space displacement or a state dependent phase space displacement.

In various embodiments, the two energy levels |0> and |1> can represent an effective spin ½ system, and the qubit states of the trapped ion 410 can be referred to as spin states. The “zero” qubit state |0> and the “one” qubit state |1> can be referred to as the “zero” spin state and the “one” spin state, respectively. In an example, the trapped ion is ¹⁷¹Yb⁺, and |0> and | 1> correspond to two hyperfine levels (e.g., F=0 and F=1) in the ground state (²S_{1/2}) of ¹⁷¹Yb⁺. The parameter F can indicate a hyperfine level. For example, |0> and | 1> are defined by the m_{F}=0 states of the ²S_{1/2} hyperfine manifold of ¹⁷¹Yb⁺: |0> is |F=0, m_{F}=0> and | 1> is |F=1, m_{F}=0>, and the frequency do is 2π×12.6 giga Hertz (GHz). The parameter m_{F} can indicate a sublevel in a hyperfine level.

In an embodiment, transitions between |0> and |1>, such as the two hyperfine levels, are driven by stimulated Raman transitions, for example, involving a virtual state |e>. For example, the trapped ion 410 starts in |0>, and is driven to |1> by absorbing a first photon from the optical beam 421 and emitting a second photon into the optical beam 422, resulting in a force in a first direction. The state |e> can be a virtual state that is detuned from other energy levels (e.g., an excited energy level ²P_{1/2}) of the trapped ion 410. Similarly, the trapped ion 410 starts in |1>, and is driven to |0> by absorbing a photon from the optical beam 422 and emitting a photon into the optical beam 421, resulting in a force in a second direction.

In some examples, instead of using Raman transitions, a direction transition occurs between two qubit states (e.g., |0> and |1>). The direction transition can be a resonant transition driven by a single pulse and without a virtual level. The single pulse can be in a frequency range of microwave (MW) or an MW spectrum.

FIG. 5 shows an example of trapped ions 531-532 in an array (e.g., the chain 110) of trapped ions of a QPU or a QIP according to an embodiment of the present disclosure. One or more trapped ions can be disposed between the trapped ions 531-532, such as shown in FIG. 5. The trapped ions 531-532 can also be adjacent to each other.

Qubits associated with the trapped ions 531-532 can be entangled, for example, a qubit state of the trapped ion 531 can be dependent on a qubit state of the trapped ion 532.

In some examples, a quantum state (or state) ψ of a two-qubit system (e.g., the qubits associated with the trapped ions 531-532) can be represented as a 4×1 vector C

$$[ \begin{matrix}{C}_{00} \\ {C}_{01} \\ {C}_{10} \\ {C}_{11}\end{matrix} ]$$

the components C₀₀, C₀₁, C₁₀, and C₁₁ of C represent an amplitude of the quantum state ψ=C₀₀|00 [symbol] +C₀₁|01 [symbol] +C₁₀|10 [symbol] +C₁₁|11 [symbol] . The amplitude can be a complex number. In an embodiment, |00> can indicate that each of the qubits is in |0>, |11> can indicate that each of the qubits is in |1>. |01> can indicate that the qubit of the trapped ion 531 is in |0> and the qubit of the trapped ion 532 is in |1>. |10> can indicate that the qubit of the trapped ion 531 is in |1> and the qubit of the trapped ion 532 is in |0>.

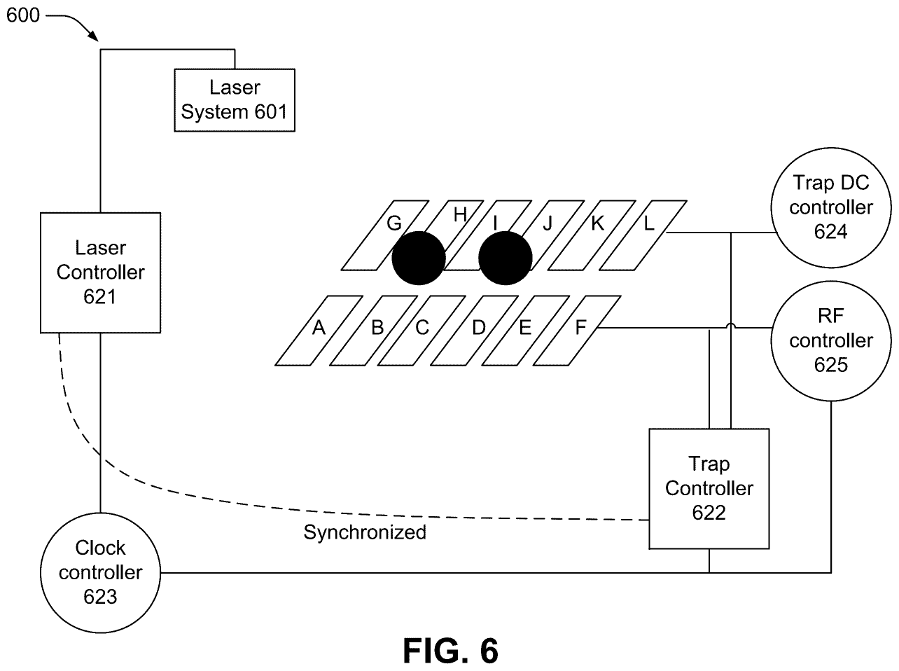

Optical beams (or optical pulses) (e.g., from an optical system or a laser system 601 in FIG. 6 or the optical and trap controller 220 in FIG. 2) can be applied to and interact with the trapped ions 531-532 to implement a two-qubit entanglement gate and drive the qubits to an entangled state. The optical beams can have any suitable combinations of spatial and temporal characteristics, such as spatial profiles (e.g., beam size(s), beam location(s)) and temporal profiles or temporal pulse shape(s) (e.g., amplitude profile(s), frequency profile(s), and/or phase profile(s)). The optical beams can propagate along any suitable propagation direction(s) and can have any suitable polarization(s).

In an embodiment, the optical beams drive the trapped ions 531-532 to an entangled state using a Mølmer-Sørensen (MS) protocol or an MS gate. The method can be suitably adapted if a different gate or protocol is used to realize an entangled state. Referring to FIG. 5, the optical beams (or optical pulses) can include the optical beams 501-504. The optical beams 501-504 can be applied to and interact with the trapped ions 531-532 in an array of trapped ion, such as the chain 110 in FIG. 1. In an example, a controller (e.g., the optical and trap controller 220 in FIG. 2, a laser controller 621 in FIG. 6, or the like) is configured to control the optical beams 501-504 spatially and temporarily.

Optical frequencies of the optical beams 501-504 can be represented by ωₐ₁, ωₐ₂, ω_{b1}, and ω_{b1}, respectively. A frequency difference Δω₁ between the optical beams 501-502 can be related to ω₀ and a parameter γ. In an example, the parameter γ is a difference between an oscillation frequency v of a motional mode of the trapped ions in the ion trap and a detuning frequency δ, e.g., γ=v−δ, ω₀ can be much larger than γ, e.g., ω₀≥Nγ, where N is 10, 100, or the like. A frequency difference Δω₂ between the optical beams 503-504 can be related to ω₀ and γ. A sum of Δω₁ and Δω₂ can be equal to 200. In an example, Δω₁=ω₀−γ, and Δω₂=ω₀+γ. In an example, the qubits associated with the trapped ions 531-532 are initially in a state |00>. When the optical beams 501-504 are applied on the trapped ions 531-532, transitions (e.g., two stimulated Raman transitions) can occur such that the qubits are driven from |00> to an entangled state, such as (|00 [symbol] −i|11 [symbol] )/\sqrt{2}. The optical beams 501-504 can overlap partially in the time domain with a temporal displacement or overlap completely in the time domain. For example, the two stimulated Raman transitions can include (i) a stimulated Raman transition between |00> and a first intermediate state with an energy difference Δω₁ and a stimulated Raman transition between the first intermediate state and |11> with an energy difference Δω₂, (ii) a stimulated Raman transition between |00> and a second intermediate state with an energy difference Δω₂ and a stimulated Raman transition between the second intermediate state and |11> with an energy difference Δω₁, and/or the like. In an example, a motional state of the trapped ions 531-532 remains unchanged.

In an example, two direct transitions (e.g., driven by two MW pulses) occur such that the qubits are driven from |00> to an entangled state, such as (|00 [symbol] −i|11 [symbol] )/√2.

FIG. 5 shows an example using four optical beams 501-504. Any suitable number of optical beams can be used to achieve the entangling gate. For example, three optical beams can be used. In an example, the optical beam 501 is the optical beam 503. In an example, the optical beam 502 is the optical beam 504.

In various examples, gate fidelities using Raman transitions are limited by scattering off an excited state, such as P_{1/2} or P_{3/2}. The scattering off the excited state can be resolved or mitigated by using a direct transition between two qubit states. For various qubit states, respective direction transitions between two of the qubit states can be in an MW spectrum. In some embodiments, spatial localization in the MW spectrum can be difficult and a speed of the transition can be slow. Further, light or optical beams in the MW frequency imparts a much smaller state dependent force than light or optical beams in the visible-UV frequencies typically used in Raman transitions. Thus, using MW frequency further slows down entangling gates, such as MS gates.

According to an embodiment of the disclosure, optical power used to achieve an entangling gate (e.g., two-qubit entangling gate) driven by Raman transition(s) can be reduced by simultaneously and coherently manipulating (i) the trap potential of the ion trap and (ii) the optical beams applied to the trapped ions. When the optical power is reduced, the scattering off the excited state can be reduced. The coherent trap potential manipulations can be designed to enhance the state dependent phase space displacements that are a key component in creating entanglement. The method and embodiments in the disclosure can be different from mechanisms that shuttle ions during a gate operation. The shuttling of ions may allow for the use of a fixed beam position to address different ions and in various examples, the shuttling of ions is not to enhance the state dependent forces and entanglement generation.

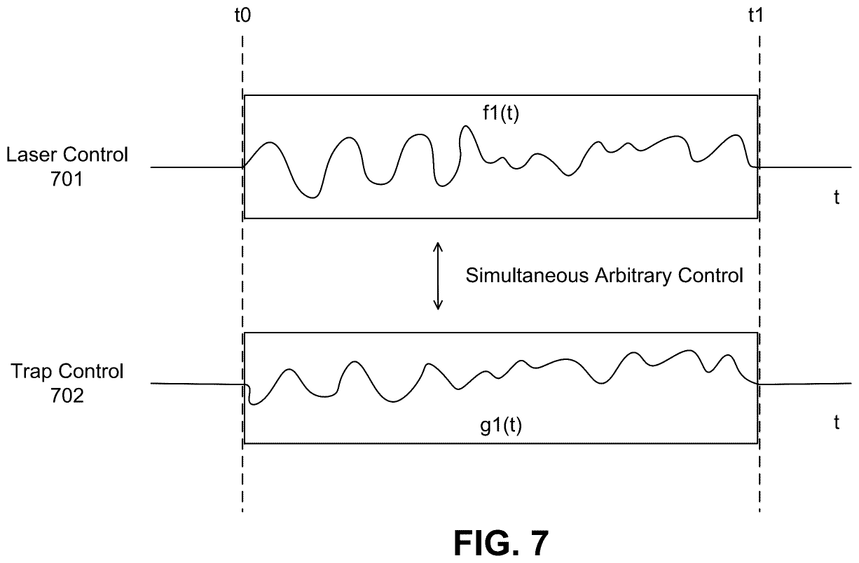

FIGS. 6-8 show embodiments that implement an entangling gate such as a two-qubit entangling gate using a continuous spin dependent force coupled with coherent trap manipulation. When the optical beams are being applied to trapped ions (e.g., the trapped ions 531-531), the trapping potential of the ion trap that traps the trapped ions can be simultaneously and continuously being manipulated, such as shown in FIG. 7. Compared with related technologies used to implement an entangling gate, continuously varying the trapping potential (e.g., continuously varying a temporal shape of the trapping potential) together with the temporal pulse shape(s) of the associated optical beams can increase state dependent forces on the trapped ions as well state dependent phase space displacements, thus realizing the entangling gate within a shorter duration and increasing a gate speed. In an example, continuously varying the trapping potential and the temporal pulse shape(s) of the associated optical beams can reduce optical power used to realize the same entangling gate. A reduction of the optical power can reduce scattering off the excited state, and thus increasing the gate fidelity. Thus, an entangling gate achieved using a continuous state dependent force (e.g., spin dependent force) coupled with a coherent trap manipulation, such as described in the disclosure, can have a higher gate speed and/or higher gate fidelity than an entangling gate implemented using related technologies.

FIG. 6 shows an exemplary QIP system 600 according to an embodiment of this disclosure. The QIP system 600 can be a variation of the QIP system 200, and can include any or all components in the QIP system 200. Further, the QIP system 600 can be configured to implement a two-qubit entangling gate using a continuous spin dependent force (or a state dependent force) coupled with a coherent manipulation of the trapping potential. The QIP system 600 can include multiple trapped ions, such as an array of trapped ions including the trapped ions 531-532 (e.g., ¹⁷¹Yb⁺) such as described in FIG. 5.

The QIP system 600 can include the ion trap (e.g., the trap described in FIG. 1 or the trap 270 in FIG. 2), the optical system (or the laser system) 601 (e.g., partially located in the optical and trap controller 220 and/or in the chamber 250 in FIG. 2), and a controller (e.g., the optical and trap controller 220 in FIG. 2). The controller can include a laser controller 621 configured to control operations of the laser system 601, a trap controller 622 configured to control operations of the ion trap, and a clock controller 623.

The ion trap can be formed using any suitable method. In an embodiment, the ion trap is an RF Paul trap formed by suitably arranging electrodes and by providing suitable voltages to control the electrodes. A trapping potential of the ion trap can be manipulated by manipulating an electrode configuration and/or by manipulating voltages applied to the electrodes. Multiple electrodes (e.g., electrodes A-L) can be arranged in a suitable configuration. In an example, the trap controller 622 is configured to control a trap DC controller 624 and an RF controller (also referred to as a resonant RF controller) 625. DC voltages can be applied to a subset of the multiple electrodes (e.g., the electrodes G-L) via the trap DC controller 624, and RF voltages can be applied to another subset of the multiple electrodes (e.g., the electrodes A-F) via the RF controller 625. Alternatively, the trap controller 622 is configured to control the DC voltages and the RF voltages at the electrodes A-L directly.

The laser system 601 can be configured to provide optical beams (e.g., the optical beams 501-504) that interact with the atoms or ions (e.g., the trapped ions 531-532) in the ion trap. The laser system 601 can provide spatial and temporal control to the optical beams 501-504. The laser system 601 can generate the optical beams 501-504 or variations of the optical beams 501-504.

The controller can be configured to control operations of the optical system 601 and the ion trap. According to an exemplary embodiment of the disclosure, the controller is configured to determine a temporal profile of a trapping potential of the ion trap and at least one characteristic of at least one optical beam (e.g., a first optical beam) in the optical beams 501-504. The first optical beam can be one of the optical beams 501-504. The first optical beam can be applied to the trapped ion 531 and/or the trapped ion 532. The controller is configured to cause the trapping potential having the determined temporal profile to be applied to the ion trap, for example, via the trap controller 622 and/or the RF controller 625. In an example, a trap frequency of the trapping potential can be changed. The controller can be configured to cause the optical beams 501-504 to be applied to the trapped ions 531-532 to implement a two-qubit entangling gate based on the trapped ions 531-532. The first optical beam with the determined at least one characteristic can be applied to the trapped ion 531 and/or the trapped ion 532.

According to an embodiment of the disclosure, the temporal profile of the trapping potential and the at least one characteristic of the first optical beam can be determined to enhance a state dependent phase space displacement to the trapped ion 531 and/or the trapped ion 532. For example, the temporal profile of the trapping potential and the at least one characteristic of the first optical beam are determined to achieve the desired two-qubit entanglement state with less optical power and/or within a shorter duration (or a faster speed). Thus, a gate speed of the two-qubit entangling gate can be increased by simultaneously manipulating the trap potential and the at least one characteristic of the first optical beam. In an embodiment, both the first optical beam in the optical beams 501-504 and the trap potential are coherently manipulated simultaneously. The first optical beam and the temporal profile of the trapping potential can be synchronized, for example, via the controller or the clock controller 623. The first optical beam and the trapping potential can be applied simultaneously.

An optical beam (e.g., the first optical beam or any one of the optical beams 501-504) can be described in a time domain using an electric field E (t) of the optical beam as below.

$$E ( t ) = A cos ( ω t + φ ) \qquad Eq . ( 1 )$$

A, ω, and φ can represent an amplitude, a frequency, and a phase of the optical beam, respectively. Each of the amplitude, the frequency, and the phase can vary with a time t or can remain constant. When the amplitude varies, A can be represented as A(t) and A(t) can be referred to as an envelope function or an amplitude profile. When the phase varies, φ can be represented as φ(t) and can be referred to as a phase profile. When the frequency varies, the term ωt can be replaced by

$$( {ω}_{0} t + {\int }_{0}^{t} {ω}_{Δ} ( τ ) d τ )$$

where an instantaneous frequency of the optical beam can be w(t)=ω₀+ω_{Δ}(t). ω(t) (or alternatively ω_{Δ}(t)) can be referred to as a frequency profile. Variations of A(t), ω(t) (or @_{Δ}(t)), and φ(t) can be much slower (e.g., with one or more magnitudes difference) than a variation of E (t).

According to an embodiment of the disclosure, the at least one characteristic of the first optical beam can include a temporal pulse shape of the first optical beam, such as described in Eq. (1) where one or more of the amplitude, the frequency, and the phase can vary with the time t as A₁(t), ω₁(t), and/or φ₁(t) such as described above. The controller can be configured to determine the temporal pulse shape of the first optical beam, for example, together with the temporal profile of the trapping potential.

In an embodiment, the temporal pulse shape includes at least one of (i) the amplitude profile A₁(t) of the temporal pulse shape, (ii) the frequency profile ω₁(t) (or ω_{Δ1}(t)) of the temporal pulse shape, and (iii) the phase profile φ₁(t) of the temporal pulse shape. The controller can be configured to determine the amplitude profile A₁(t), the frequency profile ω₁(t) (or ω_{Δ1}(t)), and the phase profile φ₁(t) of the first optical beam, for example, together with the temporal profile of the trapping potential.

In an example, the temporal pulse shape of the first optical beam includes the amplitude profile A₁(t) of the temporal pulse shape. In an example, the temporal pulse shape of the first optical beam includes the frequency profile ω₁(t) (or ω_{Δ1}(t)) of the temporal pulse shape. In an example, the temporal pulse shape of the first optical beam includes the phase profile _{φ1}(t) of the temporal pulse shape.

The controller (e.g., via the trap controller 622) can be configured to manipulate the trapping potential of the ion trap using any suitable methods. One or more electrodes in the ion trap can be controlled. In an example, voltage(s) applied to a subset of the electrodes A-L are manipulated or varied according to the determined temporal profile of the trapping potential.

FIG. 7 shows timing schematics of an exemplary temporal pulse shape f1(t) of the first optical beam and an exemplary temporal profile g1(t) of the trapping potential according to an embodiment of the disclosure. The horizontal axis indicates time t. The top row shows a laser control 701 including the temporal pulse shape f1(t) of the first optical beam. The bottom row shows a trap control 702 including the temporal profile g1(t) of the trapping potential. The specific temporal profiles f1(t) and g1(t) shown in FIG. 7 are for purposes of illustration. Any suitable temporal profiles can be selected, for example, based on specific requirements (e.g., to achieve a faster gate with a gate speed that is larger than a threshold and/or to use less optical power that is less than a threshold), and thus versatile control (e.g., arbitrary control) of the temporal profiles f1(t) and g1(t) can be applied to the optical beams and the trapping potential.

The temporal profiles f1(t) and g1(t) can be synchronized. Simultaneous and versatile control (e.g., arbitrary control) of the temporal profiles f1(t) and g1(t) can be performed. The temporal profiles f1(t) and g1(t) can have a pulsed shape from a time to to a time t1. The temporal profiles f1(t) and g1(t) can vary with time continuously. In an example, after a certain delay from the time t1, another temporal pulse shape f2(t) of the first optical beam and another temporal profile g2(t) of the trapping potential can be applied. f1(t) can be identical to f2(t) or different from f2(t). g1(t) can be identical to g2(t) or different from g2(t).

f1(t) can indicate a change to the amplitude profile, the frequency profile, and/or the phase profile of the first optical beam. g1(t) can indicate a continuous variation of the trapping potential of the ion trap with time t. In an example, g1(t) indicate a continuous variation of the trapping potential of the ion trap with time t experienced by the trapped ion 531 and/or the trapped ion 532. g1(t) can be realized by manipulating one or more trap voltages that control respective electrode(s) in the ion trap. FIG. 7 shows that the trapping potential can vary continuously. The specific shape (e.g., how the trapping potential varies with time and/or space for each trapped ion) of the trapping potential can depend on the specific apparatus (e.g., configuration of electrodes and voltages applied to the electrodes) used to generate the trapping potential. In an embodiment, g1(t) may be indicated using a vector describing the control of one or multiple electrodes at the same time. In an example of the scheme of a single control, the trapped ions may experience some changes in the trapping potential, and the trapping potential for an individual trapped ion may be less specifically tailored. In general, the shape of the trapping potential can be controlled with more outputs (electrodes), but the method can work with one output. The degrees of freedom can increase with more outputs.

In addition to the first optical beam, one or more other optical beams in the optical beams 501-504 can be manipulated similarly as the first optical beam. For example, at least one characteristic (e.g., a temporal pulse shape) of a second optical beam in the optical beams 501-504 is determined and applied to the trapped ions 531-532. The temporal pulse shape of the second optical beam can be identical to or different from the temporal pulse shape of the first optical beam.

In an embodiment, all of the optical beams 501-504 share the temporal profile (e.g., f1(t)). In an embodiment, one or more of the optical beams 501-504 share the temporal profile (e.g., f1(t)). In an embodiment, one or more of the optical beams 501-504 do not vary with time and the respective temporal profile(s) are fixed as a constant. In an example, all of the optical beams 501-504 are manipulated independently.

In an example, the optical beams 501-504 include 4 independent beams. As described above in FIG. 5, the optical beams 501-504 can be applied to the trapped ions 531-532, and drive two stimulated Raman transitions, for example, from |00> to an entangled state, such as (|00 [symbol] −i|11 [symbol] )/\vec{2}. The optical beams 501-504 can overlap completely or partially in the time domain. Respective characteristics (e.g., temporal pulse shapes as described in Eq. 1 or f1(t) in FIG. 7) of one or more of the optical beams 501-504 can be determined. In an example, the respective characteristics of the one or more of the optical beams 501-504 are determined together with the temporal profile of the trapping potential. The characteristics (e.g., the temporal pulse shapes as described in Eq. 1 or f1(t) in FIG. 7) of the one or more of the optical beams 501-504 can be synchronized with g1(t) and applied to the trapped ion 531 and/or 532. Beam propagation directions of the optical beams 501-502 can be different. Beam propagation directions of the optical beams 503-504 can be different.

In an example, the optical beams 501-504 or the optical beams 501-503 are wide beams that are applied to the trapped ion 531 as well as to the trapped ion 532.

In an example, the optical beams 502 and 504 are a single beam. The optical beam 502 (e.g., a wide beam that is collimated) is applied to the trapped ions 531-532, the optical beam 501 is focused onto the trapped ion 531, and the optical beam 503 is focused onto the trapped ion 532, i.e., the optical beam 501 is only applied to the trapped ion 531 and the optical beam 503 is only applied to the trapped ion 532.

In an embodiment, the optical beams 501-502 are applied to the trapped ion 531 where the temporal pulse shape of the optical beam 501 (e.g., the first optical beam) is determined such as described above using Eq. (1) and/or in FIG. 7. The frequencies of the optical beams 501-502 can be separated by Δω1. The optical beams 503-504 can be applied to the trapped ion 532. The frequencies of the optical beams 503-504 can be separated by Δω2. The optical beams 501-504 can be applied to the trapped ions 531-532, respectively, to implement the two-qubit entangling gate. Beam propagation directions of the optical beams 501-502 can be different. Beam propagation directions of the optical beams 503-504 can be different.

In an example, the optical beams 501-504 include 3 independent beams 501, 502, and 504, and the optical beam 503 is the optical beam 501 (e.g., the first optical beam). The beam propagation direction of the optical beam 502 is identical to the beam propagation direction of the optical beam 504. The beam propagation direction of the optical beam 501 can be different from (e.g., perpendicular to) the beam propagation direction of the optical beam 502.

In an example, the optical beams 501-504 include 3 independent beams 501-503, and the optical beam 504 is the optical beam 502. Referring back to FIG. 5, the optical beam 501-503 are applied to the trapped ions 531-532. A temporal pulse shape of the optical beam 501 (e.g., the first optical beam) is determined such as described above using Eq. (1) and/or in FIG. 7. The beam propagation direction of the optical beam 501 is identical to the beam propagation direction of the optical beam 503, and the beam propagation direction of the optical beam 501 is different from (e.g., perpendicular to) the beam propagation direction of the optical beam 502.

In an example, a temporal pulse shape of the optical beam 503 that is applied to the trapped ion 532 is determined to enhance a state dependent phase space displacement to the trapped ion 532. The optical beam 503 with the determined temporal pulse shape and the optical beam 502 can be applied to the trapped ion 532.

As indicated in FIG. 7, the trapping potential can have any suitable shape, and thus any suitable modification. The variation of the trapping potential with time can be continuous, discontinuous, or a combination of continuous variation(s) and discontinuous variation(s). State dependent force(s) (e.g., spin dependent force(s)) can be applied throughout the gate duration. For example, the optical beams impinge forces (e.g., momentum kicks) on the trapped ions continuously. The trapping potential shape can be manipulated continuously to accumulate the phase faster to realize the entangling gate.

As described with Eq. (1), the temporal pulse shape (e.g., laser pulse shapes of the optical beams) can be simultaneously changed with the trapping control (e.g., the control of the trapping potential). In an example, the control parameters of an entangling gate (e.g., an MS gate) include the laser pulse shapes of the optical beams, including but not limited to a laser amplitude profile, a laser frequency profile, and/or a laser phase profile as described above.

Functions of the controller can be implemented using any suitable hardware, software, and the like. The laser controller 621, the trap controller 622, and/or the clock controller 623 can be separate controllers or can be integrated into a single controller (e.g., the optical and trap controller 220 described in FIG. 2).

In an example, the controller described with reference to FIG. 6 can be configured to further perform functions of the optical and trap controller 220 described in FIG. 2. Alternatively, the QIP system 600 can further includes an optical and trap controller that is similar or identical to the optical and trap controller 220 described in FIG. 2.

The controller can be configured to control timings of the optical beams 501-504 interacting with the trapped ions 531-532 and the trapping potential of the ion trap, for example, via the clock controller 623 in FIG. 6. The controller (e.g., via the clock controller 623) can be configured to synchronize the temporal pulse shape(s) (e.g., f1(t)) of the optical beams 501-504 and the temporal pulse shape (e.g., g1(t)) of the trapping potential, for example, by synchronizing the operations of the laser controller 621 and the trap controller 622. The controller is also configured to provide the temporal control of the optical beams 501-504 including synchronization of the optical beams 501-504 with respect to the trapping potential. In an example, the synchronization of the temporal pulse shape(s) (e.g., f1(t)) of the optical beams 501-504 and the temporal pulse shape (e.g., g1(t)) of the trapping potential includes having the same timing between the temporal pulse shape(s) (e.g., f1(t)) of the optical beams 501-504 and the temporal pulse shape (e.g., g1(t)) of the trapping potential.

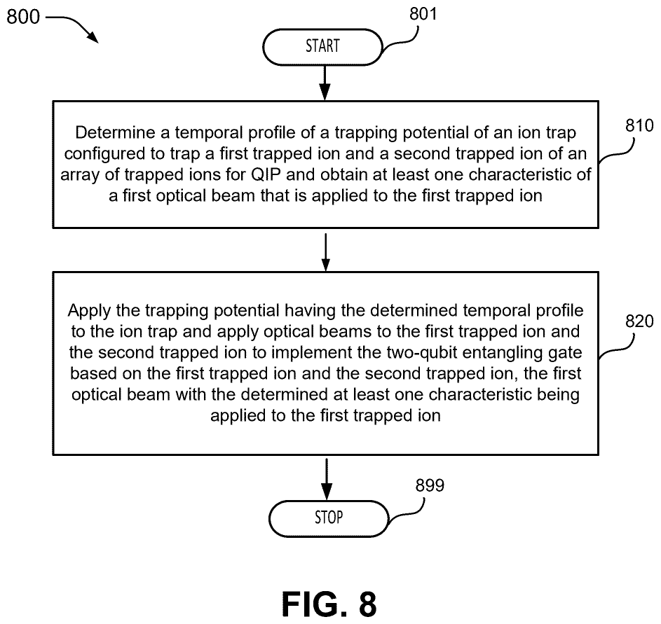

FIG. 8 illustrates a method 800 to implement a two-qubit entangling gate using a continuous spin dependent force coupled with coherent trap manipulation according to an embodiment of the present disclosure. The method 800 can be used to realize a two-qubit entangling state within a shorter duration and/or with less optical power, and thus achieving a gate with relatively higher speed and/or with higher gate fidelities. The method 800 may be performed by one or more of the QIP system 200 or 600, the computer device 300, and/or one or more subcomponents thereof as described above.

The method 800 can start at 801. An array of trapped ions for QIP are in an ion trap configured to trap the array of ions. A first trapped ion and a second trapped ion (e.g., the trapped ions 531-532) in the array of trapped ions can be in a spin state (e.g., |00>) and a motional state (|α>).

At 810, a temporal profile of a trapping potential of the ion trap and at least one characteristic of a first optical beam to be applied to at least one of the first trapped ion and the second trapped ion can be determined. In an example, the at least one characteristic of the first optical beam is obtained. The temporal profile of the trapping potential and the at least one characteristic of the first optical beam can be determined to enhance state dependent phase space displacement(s) to the at least one of the first trapped ion and the second trapped ion. For example, the at least one characteristic of the first optical beam and the associated temporal profile of the trapping potential can be optimized together such that a gate speed of the two-qubit entangling gate reaches a threshold and/or optical power used by the first optical beam is less than a threshold. The temporal profile of the trapping potential and the at least one characteristic of the first optical beam can be determined based on gate fidelity (e.g., overall gate fidelity), robustness to noisy environment and control, a gate duration (e.g., to achieve faster gates), and reduction of the minimum laser power required to run a gate. The gate fidelity (e.g., the overall gate fidelity) can include the effects of Raman scattering which may be determined separately.

In an embodiment, the at least one characteristic includes the temporal pulse shape of the first optical beam. A temporal pulse shape (e.g., f1(t) in FIG. 7) of the first optical beam is determined.

The temporal pulse shape such as described in Eq. (1) can include at least one of (i) an amplitude profile A (t) of the temporal pulse shape, (ii) a frequency profile ω(t) (or ω_{Δ}(t)) of the temporal pulse shape, or (iii) a phase profile φ(t) of the temporal pulse shape, such as described with Eq. (1).

At 820, the trapping potential having the determined temporal profile is applied to the ion trap and optical beams are applied to the first trapped ion and the second trapped ion to implement the two-qubit entangling gate based on the first trapped ion and the second trapped ion. The first optical beam with the determined at least one characteristic can be applied to the at least one of the first trapped ion and the second trapped ion. The optical beams can include the first optical beam. The first optical beam and the temporal profile of the trapping potential can be synchronized and can be applied simultaneously from a time t0 to a time t1, such as shown in FIG. 7.

In an embodiment, the first optical beam and a second optical beam are applied to the first trapped ion. The first optical beam and the second optical beam can be applied simultaneously or can overlap partially in the time domain. Frequencies of the first optical beam (e.g., the optical beam 501 in FIG. 5) and the second optical beam (e.g., the optical beam 502 in FIG. 5) can be separated by a first frequency difference Δω₁ based on an energy difference ω₀₁ of a first qubit state and a second qubit state of the first trapped ion and a pre-defined parameter γ, such as described above. A third optical beam (e.g., the optical beam 503 in FIG. 5) and a fourth optical beam (e.g., the optical beam 504 in FIG. 5) can be applied to the second trapped ion. The third optical beam and the fourth optical beam can be applied simultaneously or can overlap partially in the time domain. Frequencies of the third optical beam and the fourth optical beam can be separated by a second frequency difference Δω₂ based on an energy difference ω₀₂ of a first qubit state and a second qubit state of the second trapped ion and the pre-defined parameter γ. In an example, ω₀₁=ω₀₂.

In an example, (i) the first optical beam and the second optical beam and (ii) the third optical beam and the fourth optical beam are applied to the first trapped ion and the second trapped ion, respectively, to implement the two-qubit entangling gate. The first optical beam, the second optical beam, the third optical beam, and the fourth optical beam can be applied simultaneously or can overlap partially in the time domain. Beam propagation directions of the first optical beam and the second optical beam can be different, and beam propagation directions of the third optical beam and the fourth optical beam can be different.

In an example, the third optical beam is the first optical beam. The beam propagation direction of the second optical beam is identical to the beam propagation direction of the fourth optical beam, and the beam propagation direction of the first optical beam is different from (e.g., perpendicular to) the beam propagation direction of the second optical beam.

In an example, the second optical beam is the fourth optical beam. The beam propagation direction of the first optical beam is identical to the beam propagation direction of the third optical beam. The beam propagation direction of the first optical beam is different from (e.g., perpendicular to) the beam propagation direction of the second optical beam.

In an example, a temporal pulse shape of the third optical beam that is applied to the second trapped ion is determined to enhance a state dependent phase space displacement to the second trapped ion. The third optical beam with the determined temporal pulse shape of the third optical beam and the second optical beam are applied to the second trapped ion.

In an example, voltages at electrodes of the ion trap can be manipulated based on the determined temporal profile of the trapping potential, and the trapping potential is varied accordingly.

The method 800 proceeds to 899, and terminates.

The method 800 can be suitably adapted. Step(s) in the method 800 can be modified and/or omitted. Additional step(s) can be added. Any suitable order of implementation can be used.

In an embodiment, characteristic(s) of one or more other optical beams in the optical beams are determined. In an example, the characteristic(s) of the one or more other optical beams, the at least one characteristic of the first optical beam, and the temporal profile of the trapping potential is determined (e.g., designed) together based on requirements of gate speed, optical power, and/or the like.

The characteristic(s) can include temporal pulse shape(s) of the respective one or more other optical beams. The characteristic(s) of the one or more other optical beams can be identical to or different from the at least one characteristic of the first optical beam. In an example, the optical beams have the same characteristics, such as the same temporal pulse shape described by A(t), ω(t) (or ω_{Δ}(t)), and/or φ(t).

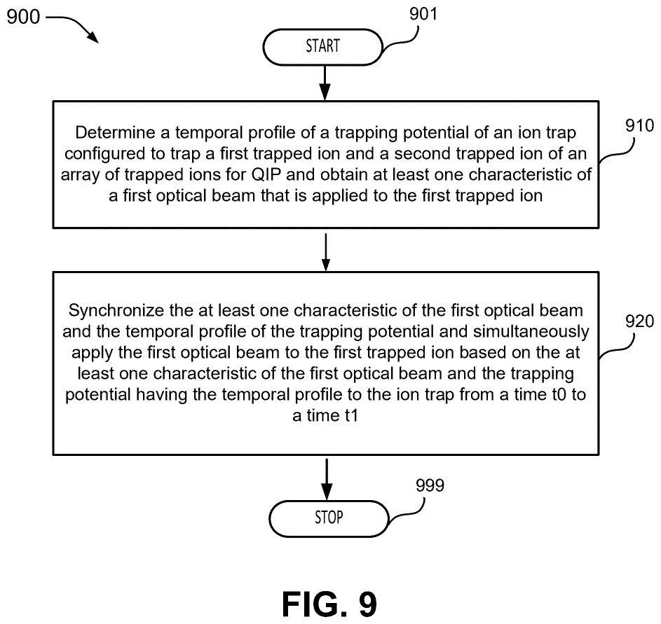

FIG. 9 illustrates a method 900 to implement a two-qubit entangling gate using a continuous spin dependent force coupled with coherent trap manipulation according to an embodiment of the present disclosure. The method 900 can be used to realize a two-qubit entangling state within a shorter duration and/or with less optical power, and thus achieving a gate with relatively higher speed and/or with higher gate fidelities. The method 900 may be performed by one or more of the QIP system 200 or 600, the computer device 300, and/or one or more subcomponents thereof as described above.

The method 900 can start at 901. An array of trapped ions for QIP are in an ion trap configured to trap the array of ions. A first trapped ion and a second trapped ion (e.g., the trapped ions 531-532) in the array of trapped ions can be in a spin state (e.g., |00>) and a motional state (|α>).

At 910, a temporal profile of a trapping potential of an ion trap configured to trap a first trapped ion and a second trapped ion of an array of trapped ions for QIP and at least one characteristic of a first optical beam that is applied to the first trapped ion may be determined. In an example, the at least one characteristic of the first optical beam is obtained.

At 920, the at least one characteristic of the first optical beam and the temporal profile of the trapping potential may be synchronized and the first optical beam to the first trapped ion based on the at least one characteristic of the first optical beam and the trapping potential having the temporal profile to the ion trap may be simultaneously applied, for example, from a time t0 to a time t1.

In an example, optical beams are applied to the first trapped ion and the second trapped ion to implement the two-qubit entangling gate based on the first trapped ion and the second trapped ion, and the optical beams include the first optical beam.

The method 900 proceeds to 999, and terminates.

The method 900 can be suitably adapted. Step(s) in the method 900 can be modified and/or omitted. Additional step(s) can be added. Any suitable order of implementation can be used. Various examples described with reference to the method 800 may be combined (with or without adaptation) in any suitable order with the step(s) in the method 900.

Embodiments described in the disclosure can be suitably adapted to implement an entangling gate of more than two trapped ions with any suitable optical beams.

Embodiments in the disclosure may be used separately or combined in any order.

The previous description of the disclosure is provided to enable a person skilled in the art to make or use the disclosure. Various modifications to the disclosure will be readily apparent to those skilled in the art, and the common principles defined herein may be applied to other variations without departing from the scope of the disclosure. Furthermore, although elements of the described aspects may be described or claimed in the singular, the plural is contemplated unless limitation to the singular is explicitly stated. Additionally, all or a portion of any aspect may be utilized with all or a portion of any other aspect, unless stated otherwise. Thus, the disclosure is not to be limited to the examples and designs described herein but is to be accorded the widest scope consistent with the principles and novel features disclosed herein.

What is claimed:

1. A method for a two-qubit entangling gate in quantum information processing (QIP), the method comprising:
determining a temporal profile of a trapping potential of an ion trap configured to trap a first trapped ion and a second trapped ion of an array of trapped ions for QIP and obtaining at least one characteristic of a first optical beam that is applied to the first trapped ion; and
synchronizing the at least one characteristic of the first optical beam and the temporal profile of the trapping potential and simultaneously applying the first optical beam to the first trapped ion based on the at least one characteristic of the first optical beam and the trapping potential having the temporal profile to the ion trap,
wherein optical beams are applied to the first trapped ion and the second trapped ion to implement the two-qubit entangling gate based on the first trapped ion and the second trapped ion, and
wherein the optical beams include the first optical beam.

2. The method of claim 1, further comprising determining the temporal profile of the trapping potential and the at least one characteristic of the first optical beam to enhance a state dependent phase space displacement to the first trapped ion.

3. The method of claim 1, wherein the determining the at least one characteristic comprises:
determining a temporal pulse shape of the first optical beam, the at least one characteristic including the temporal pulse shape of the first optical beam.

4. The method of claim 3, wherein the temporal pulse shape comprises at least one of (i) an amplitude profile of the temporal pulse shape, (ii) a frequency profile of the temporal pulse shape, or (iii) a phase profile of the temporal pulse shape.

5. The method of claim 4, wherein the temporal pulse shape comprises the amplitude profile of the temporal pulse shape.

6. The method of claim 4, wherein the temporal pulse shape comprises the frequency profile of the temporal pulse shape.

7. The method of claim 4, wherein the temporal pulse shape comprises the phase profile of the temporal pulse shape.

8. The method of claim 1, wherein the applying of the optical beams comprises:
applying the first optical beam and a second optical beam to the first trapped ion, frequencies of the first optical beam and the second optical beam being separated by a first frequency difference Δω₁ based on an energy difference ω₀₁ of a first qubit state and a second qubit state of the first trapped ion and a pre-defined parameter γ; and
applying a third optical beam and a fourth optical beam to the second trapped ion, frequencies of the third optical beam and the fourth optical beam being separated by a second frequency difference Δω₂ based on an energy difference ω₀₂ of a first qubit state and a second qubit state of the second trapped ion and the pre-defined parameter γ, (i) the first optical beam and the second optical beam and (ii) the third optical beam and the fourth optical beam being applied to the first trapped ion and the second trapped ion, respectively, to implement the two-qubit entangling gate, beam propagation directions of the first optical beam and the second optical beam being different, beam propagation directions of the third optical beam and the fourth optical beam being different.

9. The method of claim 1, wherein the applying of the optical beams comprises:
applying the first optical beam and a second optical beam to the first trapped ion, frequencies of the first optical beam and the second optical beam being separated by a first frequency difference Δω₁ based on an energy difference ω₀₁ of a first qubit state and a second qubit state of the first trapped ion and a pre-defined parameter γ; and
applying a third optical beam and the second optical beam to the second trapped ion, frequencies of the third optical beam and the second optical beam being separated by a second frequency difference Δω₂ based on an energy difference ω₀₂ of a first qubit state and a second qubit state of the second trapped ion and the pre-defined parameter γ, (i) the first optical beam and the second optical beam and (ii) the third optical beam and the second optical beam being applied to the first trapped ion and the second trapped ion, respectively, to implement the two-qubit entangling gate, a beam propagation direction of the first optical beam being identical to a beam propagation direction of the third optical beam, and the beam propagation direction of the first optical beam being perpendicular to a beam propagation direction of the second optical beam.

10. The method of claim 9, further comprising:
determining a temporal pulse shape of the third optical beam that is applied to the second trapped ion to enhance a state dependent phase space displacement to the second trapped ion;
wherein the applying of the third optical beam and the second optical beam includes applying the third optical beam with the determined temporal pulse shape of the third optical beam and the second optical beam to the second trapped ion.

11. The method of claim 1, wherein the applying of the optical beams comprises:
applying the first optical beam and a second optical beam to the first trapped ion, frequencies of the first optical beam and the second optical beam being separated by a first frequency difference Δω₁ based on an energy difference ω₀₁ of a first qubit state and a second qubit state of the first trapped ion and a pre-defined parameter γ; and
applying the first optical beam and a fourth optical beam to the second trapped ion, frequencies of the first optical beam and the fourth optical beam being separated by a second frequency difference Δω₂ based on an energy difference ω₀₂ of a first qubit state and a second qubit state of the second trapped ion and the pre-defined parameter γ, (i) the first optical beam and the second optical beam and (ii) the first optical beam and the fourth optical beam being applied to the first trapped ion and the second trapped ion, respectively, to implement the two-qubit entangling gate, a beam propagation direction of the second optical beam is identical to a beam propagation direction of the fourth optical beam, and a beam propagation direction of the first optical beam is perpendicular to the beam propagation direction of the second optical beam.

12. The method of claim 1, wherein the applying the trapping potential comprises:
manipulating voltages at electrodes of the ion trap based on the determined temporal profile of the trapping potential.

13. A quantum information processing (QIP) system, comprising:
an array of trapped ions including a first trapped ion and a second trapped ion;
an optical system configured to generate optical beams including a first optical beam applied to the first trapped ion;
an ion trap configured to trap the first trapped ion and the second trapped ion; and
a controller configured to control operations of the optical system and the ion trap including:
determining a temporal profile of a trapping potential of the ion trap and obtaining at least one characteristic of the first optical beam to enhance a state dependent phase space displacement to the first trapped ion; and
synchronizing the at least one characteristic of the first optical beam and the temporal profile of the trapping potential and simultaneously applying the first optical beam to the first trapped ion based on the at least one characteristic of the first optical beam and the trapping potential having the temporal profile to the ion trap,
wherein the optical beams are applied to the first trapped ion and the second trapped ion to implement a two-qubit entangling gate based on the first trapped ion and the second trapped ion.

14. The QIP system of claim 13, wherein the controller is configured to:
control the optical system and the ion trap to apply the first optical beam and the trapping potential simultaneously.

15. The QIP system of claim 13, wherein the controller is configured to:
determine a temporal pulse shape of the first optical beam, the at least one characteristic including the temporal pulse shape of the first optical beam.

16. The QIP system of claim 15, wherein the temporal pulse shape comprises at least one of (i) an amplitude profile of the temporal pulse shape, (ii) a frequency profile of the temporal pulse shape, or (iii) a phase profile of the temporal pulse shape.

17. The QIP system of claim 13, wherein the controller is configured to control the optical system to:
apply the first optical beam and a second optical beam to the first trapped ion, frequencies of the first optical beam and the second optical beam being separated by a first frequency difference Δω₁ based on an energy difference ω₀₁ of a first qubit state and a second qubit state of the first trapped ion and a pre-defined parameter γ; and
apply a third optical beam and a fourth optical beam to the second trapped ion, frequencies of the third optical beam and the fourth optical beam being separated by a second frequency difference Δω₂ based on an energy difference ω₀₂ of a first qubit state and a second qubit state of the second trapped ion and the pre-defined parameter γ, (i) the first optical beam and the second optical beam and (ii) the third optical beam and the fourth optical beam being applied to the first trapped ion and the second trapped ion, respectively, to implement the two-qubit entangling gate, beam propagation directions of the first optical beam and the second optical beam being different, beam propagation directions of the third optical beam and the fourth optical beam being different.

18. The QIP system of claim 13, wherein the controller is configured to control the optical system to:
apply the first optical beam and a second optical beam to the first trapped ion, frequencies of the first optical beam and the second optical beam being separated by a first frequency difference Δω1 based on an energy difference ω01 of a first qubit state and a second qubit state of the first trapped ion and a pre-defined parameter γ; and
apply a third optical beam and the second optical beam to the second trapped ion, frequencies of the third optical beam and the second optical beam being separated by a second frequency difference Δω2 based on an energy difference ω02 of a first qubit state and a second qubit state of the second trapped ion and the pre-defined parameter γ, (i) the first optical beam and the second optical beam and (ii) the third optical beam and the second optical beam being applied to the first trapped ion and the second trapped ion, respectively, to implement the two-qubit entangling gate, a beam propagation direction of the first optical beam being identical to a beam propagation direction of the third optical beam, and the beam propagation direction of the first optical beam being perpendicular to a beam propagation direction of the second optical beam.

19. The QIP system of claim 17, wherein the controller is configured to:
determine a temporal pulse shape of the third optical beam that is applied to the second trapped ion to enhance a state dependent phase space displacement to the second trapped ion; and
control the optical system to apply the third optical beam with the determined temporal pulse shape of the third optical beam and the fourth optical beam to the second trapped ion.

20. The QIP system of claim 13, wherein the controller is configured to control the optical system to:
apply the first optical beam and a second optical beam to the first trapped ion, frequencies of the first optical beam and the second optical beam being separated by a first frequency difference Δω₁ based on an energy difference ω₀₁ of a first qubit state and a second qubit state of the first trapped ion and a pre-defined parameter γ; and
apply the first optical beam and a fourth optical beam to the second trapped ion, frequencies of the first optical beam and the fourth optical beam being separated by a second frequency difference Δω₂ based on an energy difference ω02 of a first qubit state and a second qubit state of the second trapped ion and the pre-defined parameter γ, (i) the first optical beam and the second optical beam and (ii) the first optical beam and the fourth optical beam being applied to the first trapped ion and the second trapped ion, respectively, to implement the two-qubit entangling gate, a beam propagation direction of the second optical beam is identical to a beam propagation direction of the fourth optical beam, and a beam propagation direction of the first optical beam is perpendicular to the beam propagation direction of the second optical beam.
